(19) United States
(12) Patent Application Publication
(10) Pub. No.: US 2025/0148433 A1
(43) Pub. Date: May 8, 2025

(54) CONNECTED UTILITY PLATFORM

(71) Applicant: Keith Volpone, Redondo Beach, CA (US)

(72) Inventor: Keith Volpone, Redondo Beach, CA (US)

(21) Appl. No.: 18/771,418

(22) Filed: Jul. 12, 2024

Related U.S. Application Data
(60) Provisional application No. 63/526,238, filed on Jul. 12, 2023.

(51) Int. Cl. G06Q 20/06; G06Q 20/36; G06Q 20/40; G06Q 30/0226

(52) U.S. Cl. CPC G06Q 20/06; G06Q 20/36; G06Q 20/4014; G06Q 30/0227

(57) ABSTRACT

A system and method for brands and media companies who desire to collaborate with creators, customize messaging to target customers, track media efficiency, and reward user engagement, all based on their preferences and identity with the objective of driving sales and ongoing loyalty across all forms of media, live entertainment, instore experiences, sports, music and digital platforms.

### RELATED APPLICATIONS

The present invention claims benefit to U.S. provisional patent application 63/562,238.

### FIELD OF THE INVENTION

The present invention relates to a tool for online ecommerce platforms, online marketplaces, property owners, brands and media companies who desire to collaborate with creators, customize messaging to target customers, track media efficiency, and incentivize/reward user engagement, all based on their preferences and identity with the objective of driving sales and increasing user engagement across all forms of media, live entertainment, instore experiences, sports, music and digital platforms.

### BACKGROUND OF THE INVENTION

US patent publication 2022/0414621 relates to utilizing blockchain and non-fungible tokens in a gaming environment. The invention provides transferring ownership of a digital asset between a provider of the asset, a receiver of the asset, and multiple nodes in a distributed file system, including a non-fungible token (NFT) to the asset; recording the NFT on the distributed file system; receiving a request for transfer of the asset from the provider to the receiver; confirming ownership of the asset by reviewing NFT record. Blockchain is defined as a distributed public ledger, virtual or digital assets are information that can be stored, transmitted, interpreted and used that is encoded in a digital or numeric format.

US patent publication 2022/0253834 relates to implementing block-chain based content engagement platforms. The content engagement platform includes a registry service enabling verified content creators to mint non-fungible tokens (NFTs). Media wallet applications enable users to securely store NFTs or other tokens on their devices. Media wallet applications collect data of media consumed by users and aggregate the data in a permissioned analytics block chain. Users can control permission to access their personal data. Movie studios can mint digital collectibles for their movies, characters, scenes or objects. Record labels can mint digital collectibles for artists. Digital trading cards can be made from likeness or celebrities, cartoon characters or gaming avatars. NFTs minted using content engagement platforms can have multifunctional programmable use cases. This can be used by 3^{rd} party applications and platforms.

Systems utilize media wallet applications to opt-in or opt-out of sharing their consumption data, but reward them with fungible or non-fungible tokens for their participation. Users can operate in private mode, or can opt-in to sharing their data, and passively earn reward tokens from entities, such as their favorite brands and media content providers.

Media wallet includes a processor, network interface, and memory containing a media wallet application. Processor can store NFTs, where each NFT has a smart contract written to at least one immutable ledger, display a user interface through which user instructions concerning data access permissions are received; and cause media consumption data to be written to immutable ledger with data access permissions. Processor is configured by media wallet application to present an offer via user interface; and initiate transfer of tokens and cause updated data access permissions to be written to immutable ledger in response to receipt of a user instruction to accept presented offer via user interface. Processor can collect observation data, comprising at least one piece of data selected from: audio samples of ambient media; location based check-in to media viewed at a movie theater; photograph of movie ticket; screen capture of media player user interface; user submission of media content rating; data from a log file maintained on a user device.

Media wallet applications can request that the plurality of computer systems authenticate that an NFT was minted by a particular content creator. Block-chain based content engagement platforms include registry service which enable verified content creators to issue or mint NFTs. If a movie studio owns a virtual media property, like an animated character from a movie, that studio can utilize content engagement platform to mint an NFT to tokenize the character into a digital collectible. Each collectible is unique and serialized.

Media wallet application can collect observations concerning media consumption behavior and can be present when the user is consuming media such as viewing content of home or movie theater, then the media wallet application can capture observations relate to media playback on device using data from media services, audio samples of ambient media, location based check-in with respect to media viewed at a movie theater, photos of movie tickets, screen captures of media player user interfaces or media players during media playback, or user submission of a media content rating.

If a user is identified to be watching a movie on a streaming platform, a pop-up notification might alert the user about an exclusive deal to buy merchandise related to that movie at discounted rates not available elsewhere. Also, a user streaming an album on a platform just released, an application stored on user device and communicating with content engagement platform can identify media content, the content creator could send a direct push notification to user to offer them to participate in a survey providing them feedback on the content. For their participation, content creator can reward listener with tokens while gaining real-time feedback from consumer. System acts as a real-time point of sale opportunity for artists and brands to collaborate beyond running ads and sponsorships. By paying for goods using fungible tokens, both the artist and brands can be compensated responsibly for sales generated by the campaign.

There is currently a lack of integrated connected utility platform for brands and media companies who desire to customize messaging to target customers, track media efficiency, and reward user engagement, all based on their preferences and identity with the objective of driving sales and ongoing loyalty across all forms of media, live entertainment, instore experiences, sports, music and digital platforms.

### SUMMARY OF THE INVENTION

The present invention provides a method of integrating partner infrastructures through internal system APIs and blockchain technology to validate ownership or participation, securely distribute benefits, and enhance user experiences with seamless, personalized interactions.

The present invention relates to an innovative software platform, designed to bridge commerce platforms with a variety of utility feature integrations, enhancing the consumer experience beyond the initial point of sale. It is an object of the present invention to support both Web 2 and Web 3 environments, making it adaptable and capable of connecting different companies and technology infrastructures seamlessly.

It is an object of the present invention for the system to validate ownership or participation and link this information to an external platform. This is done by ownership and participation validation; benefit distribution and secure and personalized experience.

With regards to ownership and participation validation it is an object of the present invention for the system to employ a combination of APIs and blockchain technology to validate ownership or participation. By interfacing with the provider's internal infrastructure, the platform ensures that user data is accurately and securely transmitted. Multiple APIs and webhooks are utilized to authenticate user identity, ensuring that individuals are who they claim to be and possess the requisite rights to access and process information. This secure validation mechanism is foundational to the system's powered sequence, which reliably distributes the appropriate benefits to the user. It is an object of the present invention for URI mapping to be incorporated as a supplementary validation method to enhance the robustness of the verification process.

With regards to benefit distribution, it is an object of the present invention that once validation is complete, the system sequences the distribution of benefits associated with the initial touchpoint. It is an object of the present invention for this to include unlocking additional features and providing continuous benefits.

With regards to secure and personalized experience, it is an object of the present invention for the system to ensure that customers receive a secure and personalized experience by managing and distributing benefits seamlessly.

It is an object of the present invention for the system to provide consumers with a range of benefits that enhance their interactions. It is an object of the present invention to provide loyalty programs that encourage repeat engagements through reward systems.

It is an object of the present invention for the system to provide integrated ticketing solutions that facilitate seamless event access and participation.

It is an object of the present invention for the system to offer code redemption, promotional codes and discounts to enhance the value of interactions.

It is an object of the present invention for the system to offer interactive fan experiences, engaging consumers with interactive content and experience.

It is an object of the present invention for the system to provide giveaways and exclusive digital content.

It is an object of the present invention for the system to provide branded mini-games and interactive content to keep consumers engaged and connected with the brand. It is an object of the present invention for the system to provide data monetization which enables end user to harness and monetize their own data, turning insights from engagements into actionable improvements.

The present invention provides a significant halo effect for brands by offering unique post-engagement experiences that are directly linked to the brand equity through other channels. This results in strengthened brand loyalty by providing continuous engagement and value-added experiences. This further results in improved brand perception due to additional value provided to customers. This also results in multiple touchpoints with consumers that fosters long-term relationships and enhancing customer retention.

The system of the present invention provides an impact on commerce platforms and real estate. The system transforms existing infrastructure into dynamic ecosystems, enabling the offering of unique bundled benefits to consumers. This leads to increased customer satisfaction due to enriched interaction experience. It further leads to enhanced engagement and loyalty through continuous benefits. It also leads to improved margins and interaction frequency driven by sustained consumer engagement.

The present invention serves as a platform enabling companies to collaborate, share experiences and content, create a seamless B2B bridge offering connected utility and insight. This streamlines operations and enhances similar partnerships.

It is an object of the present invention for the system to power a variety of post-engagement branded utilities, enhancing the value proposition for consumers and brands alike.

It is an object of the present invention for the system to provide code redemption that enables consumers to redeem promotional codes for discounts and special offers.

It is an object of the present invention for the system to provide ticketing, including a seamless access to events and experiences.

It is an object of the present invention for the system to provide interactive content, engaging consumers with interactive digital content.

It is an object of the present invention for the system to provide a sweepstakes that offers consumers chances to win prizes and exclusive offers.

It is an object of the present invention to the system to provide fan experiences.

The present invention provides bundling of branded digital products and experiences with the initial point of sale, enhancing consumer engagement and perceived value. This approach allows brands to offer a cohesive package of physical and digital benefits that extend beyond the initial transaction. The concept of bundling involves several critical elements.

One of the critical elements is enhanced consumer value. By offering bundled digital benefits alongside physical products, brands can significantly increase the perceived value of their offerings. Consumers are more likely to perceive bundled products as offering better deals, leading to higher satisfaction and increase purchase likelihood.

It is an object of the present invention to provide seamless integration that ensures that digital benefits are seamlessly integrated with the physical products. This integration can include exclusive content, loyalty rewards, promotional codes, and access to unique experiences. Customers receive a unified experience.

It is an object of the present invention for the system to provide an extended engagement by providing bundles which create long-term engagement opportunities by providing consumers with ongoing benefits. For example, purchasing a product could unlock access to a series of digital experiences or content updates, keeping consumers engaged with the brand overtime.

It is an object of the present invention for the system to create increased brand loyalty, by offering bundled benefits which continuously reward consumers for their purchases. This ongoing engagement builds a deeper connection between the consumer and the brand, fostering loyalty and encouraging repeat business.

It is an object of the present invention for the system to create higher margins and average order value, AOV. Consumers are often willing to pay a premium for bundled products that offer additional value, allowing brands to increase their profit margins.

It is an object of the present invention for the system to provide customizable bundles that are tailored to different consumer segments. This customization ensures that the bundles resonate with the target audience, enhancing their effectiveness and appeal.

It is an object of the present invention for the system to create cross-promotional opportunities. For example, a physical product purchase could include a discount code for a related digital service, encouraging consumers to explore more of what the brand offers.

It is an object of the present invention for the system to create data-driven insights. Bundling provides valuable data insights into consumer preferences and behavior. Brands can analyze how different bundles perform and adjust their strategies accordingly, ensuring they continually meet consumer needs and preferences.

The present invention relates to a blockchain, a distributed database or ledger that creates a secure decentralized relationship between parties, allowing for a direct exchange of information, content, assets, rewards, and management of data with permission-based sharing to intermediaries or other third parties.

It is an object of the present invention for the assets to include tickets, loyalty, rewards, tokens, Chat Bots, AI, virtual apparel, digital goods, Skins, and digital twins with physical applications.

It is an object of the present invention for the content to include Music, audio files, video, products, experiences such as concerts, exhibitions, pop-ups, sporting events, art exhibits; mobile games, pc games, console games, blockchain games, play to earn games, films, television, social media content and podcasts.

The present invention relates to the establishment of an interconnected ecosystem that provides and enables users, companies, influencers, athletes, IP Holders, mobile platforms, AI, municipalities, real estate owners, retail, nonprofit organizations, tourism, hospitality, and institutions to engage directly with each other, pier to-pier, B to C, D to C, and B to B.

The present invention allows users to buy, sell, trade, share, post, view, memorialize, comment, profit, and redeem from any use of data, content, assets, rewards, and information.

The present invention relates to a holistic operating system composed of decentralized APIs (dAPIs) that are interoperable and connected.

It is an object of the present invention for the system to be an end-to-end solution that works across any blockchain platform, wallet, loyalty reward program, digital network, operating system, social platform, gaming platform, mobile platform, pc platform, connected device, media platform, connected products, consoles, physical location, live event, CRM, accounting for scale, security, and utility.

The present invention relates to digital ecosystems, which include non-fungible tokens (NFTs), Avatars, Digital Apparel, Skins, DAO's, dApps, virtual real estate and hybrid programming, creators, and building dynamic media experiences for consumers, brands, businesses, franchises, institutions, media outlets, OOH networks, game environments, gaming platforms, mobile platforms, referred to as the Metaverse.

It is an object of the present invention to have a marketing system that includes tools such as wallets, tokens, digital goods, chatbots, airdrops, NFC, RFID, Avatars, NFT Generative Engines, AI Generative Engines, and services such as social media management, content management systems, data management, consumer segmentation, addressable media, reward redemption and digital market place management, for creators, brands, consumers and businesses.

It is an object of the present invention for the system to have tokenized loyalty programs.

It is an object of the present invention for the system to have personal data monetization.

It is an object of the present invention for the system to have ad fraud prevention.

It is an object of the present invention for the system to have engagement verification.

It is an object of the present invention for the system to provide 1:1 consumer relationship.

It is an object of the present invention for the system to provide social commerce.

It is an object of the present invention to have a FARM, a data driven tool seamlessly connecting creators and brands directly to consumers and fans.

It is an object of the present invention to create Advatars, brand based dynamic objects across a hybrid media network.

It is an object of the present invention for the system to provide to creators a M.Studios, a creative sandbox offering open-source production and editing tools.

It is an object of the present invention for the system to provide to creators String, a content management tool that tracks asset contributions of all creators and ensures proper payment.

It is an object of the present invention for the system to provide to creators, ALT, a decentralized streaming media ecosystem.

It is an object of the present invention for the system to provide consumers a Data Garden, a dApp based personalized data management tool.

It is an object of the present invention for the system to provide consumers with My Token, a personal token offered by the owner to brands for direct marketing rights.

It is an object of the present invention for the system to provide 3Mail, a permission-based tokenized communication tool.

The present invention allows a consumer to visit an e-commerce platform and see a physical object for sale with bundle digital utilities attached.

It is an object of the present invention for these utilities to include an entry into a giveaway.

It is an object of the present invention for the giveaway to include a ticket to an event or a discount to a store. The products can have a QR code or a scannable ID associated with the product.

It is an object of the present invention for the consumer to purchase the product with the bundled digital utilities. Upon receipt of the good or verification of purchase, an email or instructions are sent to the customer directing them to scan a QR code or click a link that is provided. Once the user clicks the link, they are brought in the system to an extension of the product offer.

In the system the user is prompted to login from the e-commerce provider from which the originally purchased the product. It is an object of the present invention when the user logs in the system can create a block chain wallet or basic Web II account depending on the platform. Once the user logs in and their information is verified through the e-commerce providers platform APIs or customer APIs, the system validates the purchaser of the product and ensures the benefits have not yet been claimed by checking the purchase history through the e-commerce platforms internal records tied through the records.

It is an object of the present invention for the system to imprint sales data onto its block chain-database ensuring swift and secure data validation with an initial provenance. This database structure validates ownership of the original product and then executes a utility mechanism based on the selected options via the user interface. In this case, the user has proven they own the product and have yet to claim the digital benefits associated with the item.

It is an object of the present invention that with access to the system, the consumer can claim up to three benefits. For the discount code, when the user presses a claim button in the system platform, the back end system validates that the codes are unused and registered to the originating brand, securely processing and delivering the code to the user.

It is an object of the present invention that the user can copy a code or press a button that copies it to the clipboard.

For a ticket, the delivery function works similarly but delivers a file that can be added to the user's Apple Wallet following Apple's standard progression. All codes are saved to the consumer's account on the system.

It is an object of the present invention for the giveaway entry functions to be provided similar to the previous benefits, but include an additional step where the user enters and submits additional information. The back end system then validates this information from internal records and processes it if correct.

It is an object of the system to use any offer product, promotion or reward.

The present invention relates to a system for use with a residential tenant in a mixed use building. The system allows a tenant to sign a lease for an apartment in the mix use building. It is an object of the present invention for the mix use building to include commercial retail space on ground floor and residential apartments on the upper floors. The lease terms detail the amenities available within the building.

It is an object of the present invention for the ground floor to include a specialized kiosk, OOH screen or a hardware unit that serves as the system hub for the buildings residential tenants. These specialized kiosks, OOH screens or hardware solutions can be used on any floor, indoor or outdoor and can be used as physical entry points into the systems digital eco system.

It is an object of the present invention that once the lease is signed, the building management instructs the tenant to make an account of the system using their email or by signing in with a social platform, such as, Google or Facebook. This login is used for both the system, as well as paying bills, rent, and collecting amenity passes as per their lease terms. Once the tenant creates an account, they gain access to the digital touch point of the system, which they can access on their devices or interact directly at the kiosk.

It is an object of the present invention for the tenant, as part of their lease, to receive several amenities, including monthly benefits for streaming video services on subscriptions, gift cards, and the ability to charge a unique partner benefit each month depending on their lease payment status, early or late.

It is an object of the present invention to provide streaming video service rebates. The tenant logins to the system and selects the streaming video service rebate option. The system validates the tenants lease status and payment history, ensuring the benefit rebate is due. Once validated the rebate is processed and the tenant receives a credit or reimbursement for the streaming video service.

It is an object of the present invention to provide a partner gift card. To claim the gift card, the tenant selects the gift card benefit option in the system. The back end system verifies the tenants eligibility, checks the availability of the gift cards and securely delivers the gift card to the tenant's account. The tenant can then redeem the gift card to their device.

It is an object of the present invention to provide monthly benefits.

Depending on their lease payment status, tenants can choose a unique monthly benefit. They select the desired benefit from a list of options in the system. The system verifies the tenant's eligibility and processes the chosen benefit, whether it be a discount at a local retailer, an additional amenity pass, or another special offer. The benefit is then securely delivered to the tenant's system account.

The present invention relates to a system for use with a commercial retail tenant in a mixed use building.

It is an object of the present invention for a commercial retail tenant to sign a lease for a retail space on the ground floor of a mixed use building. The lease includes various benefits and utilities and customer engagement.

It is an object of the present invention that upon signing the lease, the retail tenant is instructed to create an account in the system using their business email or by signing with a business related system. This account will be used for managing lease payments, accessing utilities, and claiming business related benefits.

It is an object of the present invention for a commercial retail tenant to receive several utilities and benefits as part of their lease agreement. These might include promotional support, digital marketing credits and customer engaging tools. It is an object of the present invention for the system to provide promotional support. The retail tenant logs into the system and selects the promotional support option. The system verifies the lease status and ensures the tenant is eligible for promotional support. Once validated, the promotional materials or credits are processed and delivered to the tenant's account, ready to be used for marketing campaigns.

It is an object of the present invention to provide digital marketing credits. To claim digital marketing credits, the tenant selects this option in the system. The backend system verifies the eligibility and availability of the credits. Once verified, the credits are securely delivered to the tenant's system account, where they are applied to various digital marketing platforms.

It is an object of the present invention to provide customer engagement tools. The retail tenant can choose from a suite of customer engagement tools offered through the system. It is an object of the present invention for the tools to include loyalty programs, interactive content, or special event access. The tenant selects the desired tools, and the system verifies their eligibility. Once approved, the tools are activated and integrated into the tenant's operations, enhancing customer engagement and satisfaction.

The present invention relates to a use for an in-store retail experience. A consumer arrives to a retail location and purchases a shirt. Upon making the purchase, the user scans the code associated with the tag on the shirt, which directs them to the system which presents the user with access to specific benefits. It is an object of the present invention for the benefits to be an entry into sweepstakes and access to a fantasy sports competition.

It is an object of the present invention for the system to have an account creation or Login. The user creates an account or logs into an existing account. This account is used to manage their benefits and interact with the platform of the present invention.

It is an object of the present invention for the system to have tag validation. The system of the present invention validates the tag associated with the shirt by checking its status in the system to ensure it is active and valid. This verification ensures that the benefits can be claimed by the rightful purchaser of the product.

It is an object of the present invention for the system to allow a user to access benefits. Once the tag is validated, the user gains access to the system where they can claim their benefits. The process for each benefit follows standard redemption procedures as follows: For a sweepstakes entry, a user selects the sweepstakes entry option in the system. The backend system verifies the user's eligibility, processes the entry, and confirms participation in the sweepstakes. Another redemption is for a fantasy sports competition. The user selects the fantasy sports competition option. The backend system verifies eligibility and provides access to the competition. The user receives the necessary information and resources to participate, all managed through the system.

The present invention relates to a use for a sporting, music or live event. It is an object of the present invention for a consumer to purchase a ticket to an event, which includes bundled digital utilities with inherent benefits. As the user approaches the venue, a geofence alert activates, notifying the ticket holder of the benefits associated with their ticket. It is an object of these benefits to include a discount merchandise in the venue, a free concession item or drink from a partner sponsor, or access to an exclusive event within the venue.

It is an object of the present invention for a user to claim these benefits by clicking a link in the notification that is directed to the system of the present invention. The user logs in with their information from the ticketing provider or the event. If the user does not already have an account, one is created for them on the system, tied to their account from either the event or the ticket provider.

The present invention provides uses for exclusive event access. It is an object of the present invention for a consumer to receive exclusive event access as a benefit for purchasing a product or services. It is an object of the present invention for the process for claiming this benefit to include a user receiving an invitation or notification about the exclusive event access and is directed to claim the benefit through the system. It is an object of the present invention to provide this through a link provided in an email, SMS or through the system platform.

It is an object of the present invention for the system to have an account creation or login. The user logs into their existing system account or creates a new one if they do not already have an account. This account is used to manage their benefits and interact with the system's platform.

It is an object of the present invention for the system to provide verification and validation. The system's backend system verifies the user's eligibility for the exclusive event access. It is an object of the present invention for this to involve checking the purchase history, event invitations, or other criteria to ensure the user qualifies for the benefit.

It is an object of the present invention for the system to provide delivery of a digital ticket. Once the user's eligibility is confirmed, the backend system delivers an entry pass or digital ticket to the user. This ticket is designed to be easily added to a user's digital wallet (e.g., Apple Wallet or Google Wallet) for convenient access during the event.

It is an object of the present invention for the system to provide access to the event. The user can use their digital ticket to gain entry to the exclusive event. The digital ticket includes all necessary information and barcodes/QR codes for seamless entry.

It is an object of the present invention for all benefits to be saved to the user's account on the system ensuring seamless and personalized experience.

It is an object of the present invention for the system to provide secure validation and delivery. This structured approach guarantees that the benefits are securely validated and delivered efficiently, enhancing the overall experience for the consumer attending the event.

It is an object of the present invention to provide specialized kiosks and OOH screens. The system of the present invention uses specialized kiosks, OOH screens or hardware units that service as the system for the building's tenants. These specialized kiosks and screens can be used on any floor, indoor or outdoor, as physical entry points into the systems digital ecosystem.

It is an object of the present invention for the system to enable brands to create utility driven benefits that resonate with consumers long after the initial point of sale.

It is an object of the present invention for the system to bundle branded digital products and experiences with the initial point of sale.

It is an object of the present invention for the system to provide bundles that offer consumers more perceived value and a longer tail of engagement with the brand.

### BRIEF DESCRIPTION OF THE DRAWINGS

FIG. 1a is a flow chart regarding an on-chain digital management tool of the present invention.

FIG. 1b is a flow chart regarding an on-chain asset management tool of the present invention.

FIG. 2 is a flow chart regarding a web marketing tool that comprises Consumer Identity, Fan relationship management and On-chain creator tools.

FIG. 3 is a chart showing Core experience flow, Web3 tools and Use case of the present invention.

FIG. 4 shows a flow chart showing the experience to a user of the present invention.

FIG. 5 shows the database, dashboard and platform of the present invention.

FIG. 6 shows the utility offered by the system of the present invention.

### DETAILED DESCRIPTION OF THE INVENTION

The system of the present invention provides uses in E-commerce and Retail. In an embodiment the system of the present invention integrates loyalty program that reward repeat purchases and encourages long-term customer relationships. The system offers integrated ticketing solutions for events, providing a seamless experience from purchase to attendance. The system simplifies the redemption of promotional codes, enhancing the overall purchase value.

The system of the present invention provides uses for real estate and physical locations. In an embodiment the system utilizes geofencing to trigger digital interactions and benefits when consumers enter specific physical locations. The system implements QR codes at physical locations to link to digital experiences or unlock benefits. The system deploys interactive screens and charging stations that offer digital content and engagement opportunities. The system connects benefits, features and rewards to tenants or bystanders by bridging real estate infrastructure to directed parties.

The system of the present invention provides uses for data insight and monetization. The system collects and analyzes data from consumer engagements to improve offerings and make data-driven decisions. The system enables end users to harness and monetize their own data, providing a new revenue stream and enhancing consumer experience.

The system of the present invention provides uses for B2B collaborations. The system facilitates collaborations between companies to share experiences and content, creating a seamless B2B bridge. The system offers connected utility and insights that drive mutual benefits for partnering companies.

Fan Relationship Management relates to engagement tactics and customized rewards for fan bases with brands. This is used in industries such as, sports, fashion, film, loyalty, media, experiences, music and entertainment. FARM is built around a data-led, creative-fed approach to marketing, allowing for real-time content, utility, incentives, and loyalty rewards to be produced and delivered in context to consumers' needs and desires. Fan Relationship management connects physical experiences with digital goods and supplemental information that enhances and rewards the relationship between brands and Consumers. The platform is managed through a centralized database with a customized dashboard enabling brands to offer physical and digital benefits, including reward tokens, POAPs, digital twins, nfts, loyalty points, onsite access, merchandise drops, and event invitations, all of these benefits are tracked on chain allowing the consumer to manage, maintain and monetize their past current and ongoing activations with brands, celebrities, content, and experiences using AI, Chatbots, calls to action, loyalty rewards, incentives, promotions and day to day connectivity.

Advatars are branded objects placed in both physical and digital environments creating a connected gateway between the consumer and brand. This DOOH network enables users to access, promote and earn from featuring, wearing or displaying any digital content, fashion and other visual representations of products or brand marks in the Metaverse, game environments, media channels, social media via augmented reality, 2d or 3d imaging. Once activated, consumers can interact and share these assets via their mobile devices, computers, consoles, and media platforms and receive the associated benefits. To support this, the system uses dynamic media units that incorporate video, audio, stills, images, and animation, enabling access to immersive experiences, original content, and virtual products.

M.Studios is a blockchain-based, open-source platform that provides tools, plug-ins, and resources such as Script development, virtual writers' rooms, Virtual Pre Production, Virtual Casting, Virtual Environments, Virtual Lighting, Asset libraries, Digital Props, Virtual Stages, Virtual Wardrobe, Digital Foley, Music, Digital Camera types, filters and Lenses, Virtual editing, viewing, Minting and distribution of content direct to interested and aligned audiences address content development, production, funding and monetization, cross-promotion and partner management through smart contracts. Asset libraries include virtual humans, digital sets and props, rights-free music, and wardrobe provided by community members. Each submitted asset is evaluated by a Peer Review Board and, once accepted, is released to the community for usage under a smart contract. For example, an artist, creator, designer, developer or IP owner could create a digital asset, wardrobe, prop, or any other artifact or piece of content, which would then be reviewed by industry peers and, once approved, based on design criteria would be minted on-chain and placed into a public library accessible, licensable and trackable to 3^{rd} party creators and members of the community.

String is a blockchain-based rights management tool that tracks the contributions of community members in creating content and other digital assets. When those assets are used, the smart contract automatically executes transactions between creators, consumers, distributors, licensors, and sometimes brand partners without an intermediary. The platform allows users to search for an asset and see every individual involved in the development from inception to delivery and search and use of each asset. String offers a transparent revenue-sharing model that immediately collects and pays creators their share of royalties. Under this structure string takes a fee on each transaction and artists keep more of the value they create and get paid as people share and consume their work in real time.

ALT offers creators a decentralized streaming media ecosystem where viewers not only watch and interact with the stream, earning tokens, collectibles and a wide variety of digital goods, but also participate in developing and producing the content. ALT uses NFTs or digital tokens to authenticate and verify a viewer's membership, providing the holder with exclusive access and unique benefits. Every program has a set of related NFTs or digital tokens, which give creators, IP owners, and media companies, control of the project, and viewers/fans the chance to participate and earn via Alt's View2Earn. Viewers/fans can attend their favorite shows live or join shared viewings of movies or sporting events, with other fans and earn Avatars, digital fashion, and themed experiences associated with each property. The system has a virtual studio to extend content of creators, allowing for community-focused events, experiences, Live AMA's, and other Avatar led experiences.

In an embodiment, the system comprises a Data Garden which allows consumers to manage all data that has been collected about them by brands, publishers, web sites and other media platforms based on their activities in both physical and digital environments. Consumers can view this data in real-time, remove information which they do not desire marketers or other data aggregators to access and can also select the data which they desire to offer to brands at a user established rate. Utilizing the Data Garden, brands have the opportunity to establish open, direct relationships with their consumers by accepting the users offer or making a counter-offer per the value assessed by the brand. In a decentralized environment, each consumer owns their personal data, and can manage and secure it on the blockchain, independent of any one particular loyalty program, subscription or club, and choose which brands they share their data with in order to receive perks, rewards and experiences customized to their preferences. The Data Garden directly relates to My Token, which is a value based, personalized token that the user sells to a brand for a stipulated period of time and is utilized by the brand to access the user permitted information (see previously defined My Token).

The Web3 Marketing system provides Decentralized Identity (DiD) to consumers who have registered on the platform and selected to opt-in to create a DiD, giving them personal control of their identity through the use of the Data Garden and verified information that has been collected from certified users, i.e., the Government. By controlling what information is shared from the Garden to requesting third parties, the user is able to better manage their identity and their privacy, i.e., only presenting proof that they're over 18 without needing to reveal their actual date of birth. The Data Garden enables consumers to manage and monetize their personal data.

The Web3 Marketing system features My Token, a personalized digital asset tied to an individual that represents social identity in a decentralized society. Individuals can mint and issue NFTs (tokens) that represent their backgrounds, interests and affiliations, as well as other permission based information which has been collected or registered by the user. My Token can be issued to brands, organizations and others directly, verifying their personal identity and stipulating their specific interests from the receiver. These personal tokens replace traditional loyalty program points and establish ones value and reputation within the community.

The Web3 Marketing system provides Blockchain Tickets, non-fungible assets that are unique, transparent, and immutable. Blockchain tickets are useful in terms of anti-counterfeiting, secondary market sale and transference, and other utility based applications such as personal customization. As a collectible, digital technology enables the holder to eliminate the small rips, folds and stickers that devalue the physical ticket as a collectible. As an NFT, the system also enables the ticket to be dynamic, collecting “daughter” assets as an event, which can unlock new experiences and provide more customization and personalization. This feature of the current invention encourages fans to engage with all activities, vendors, brand partners and other experiences going on at the venue through gamification.

The system of the present invention has industry applications in sports, music, film/television, retail, hospitality and financial services.

### Example 1: Sporting Event

A consumer purchases a ticket. Upon stadium entry or prior, the consumer redeems their ticket for an NFT ticket. The consumer arrives at the venue and receives a text alert about partner experiences and other onsite activities. Consumer engages in partner experiences and/or purchases products from vendors and receives digital pins/stickers from the partner or brand. Upon collecting all pins/stickers, the consumer receives a physical and/or digital gift. The ticket can also be sold in the secondary market or staked by another user for a future event.

### Example 2: Feature Film

A consumer at a bus stop, subway station or any other public place featuring out-of-home media, points their phone at a movie poster. Using computervision, the phone captures the film's logo or other key art on the movie poster, and delivers the movie trailer to the users phone. The consumer watches the trailer and is prompted to purchase movie tickets for their local/preferred theater. This is delivered by threading the GPS coordinates and other data from their phone or Data Garden to the ticketing dApp. The consumer purchases tickets and receives a collectible NFT ticket which has a degree of rarity. The consumer receives a film reminder, mini-game and wall paper several days before their scheduled attendance of the film in theater. Upon visiting the theater, the consumer scans the ticket for entry. After the film, the consumer is air dropped digital trading cards which are representative of the film IP and other studio based assets. Digital trading cards become more rare each week at the theater driving users to frequent and view the film more times. Cards are also available from film Promo Partners.

### Example 3: Apparel & Other Physical Goods

Consumer visits retailer in the physical or digital world and purchases apparel or other goods. Upon receipt of the good, they scan the tag, label or other digital tool such as RFID or NFC, and is prompted to activate their Digital Twin. The Digital Twin (NFT) maintains and enables the following on the blockchain: manufacturing history and provenance of the garment; ownership verification; an Avatar and Augmented Reality (AR) version. This digital asset can be utilized by the owner's insurance company or other professional service provider, verifying ownership and enabling owner to log the value of the asset on their insurance policy or other asset management tool. The digital twin, which is housed in a virtual custodial wallet or other digital asset storage and management tool, establishes a 1:1 connection between the Brand and the Owner, offering access to future product drops, event invitations, sales, and other brand activities or benefits.

### Example 4: Music

A band releases a new single and invites fans to join their fan club. Upon signing up, they receive a dynamically generated NFT which can include a character image, instrument, lyrics, beats, stems and other digital music elements. Fans connect with other NFT Holders and an AI producer within the virtual studio to compose original song(s) with on-chain music assets. Fans can then load their NFT assets into an open source music library for song making. Collaborators publish (Mint) and distribute NFT single or album.

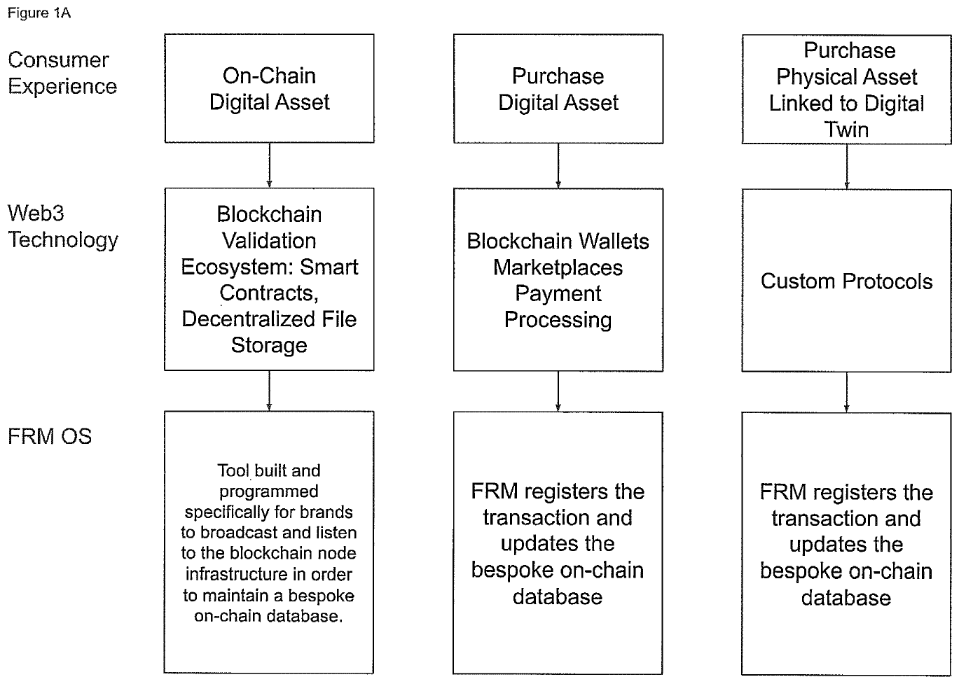

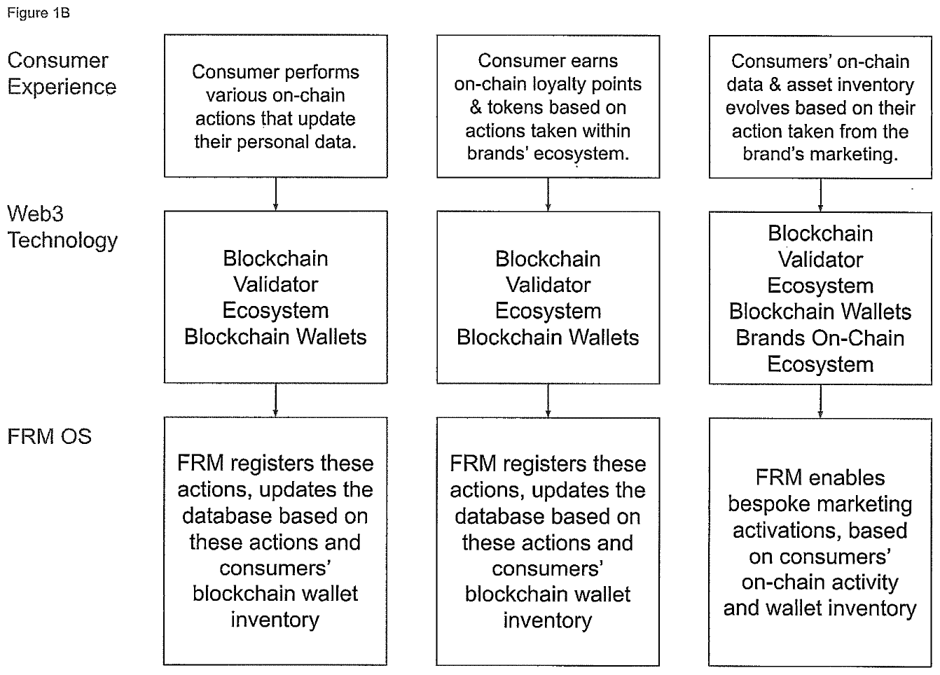

FIGS. 1a and 1b show an On-chain digital management tool showing the consumer experience; web3 technology and FRM OS.

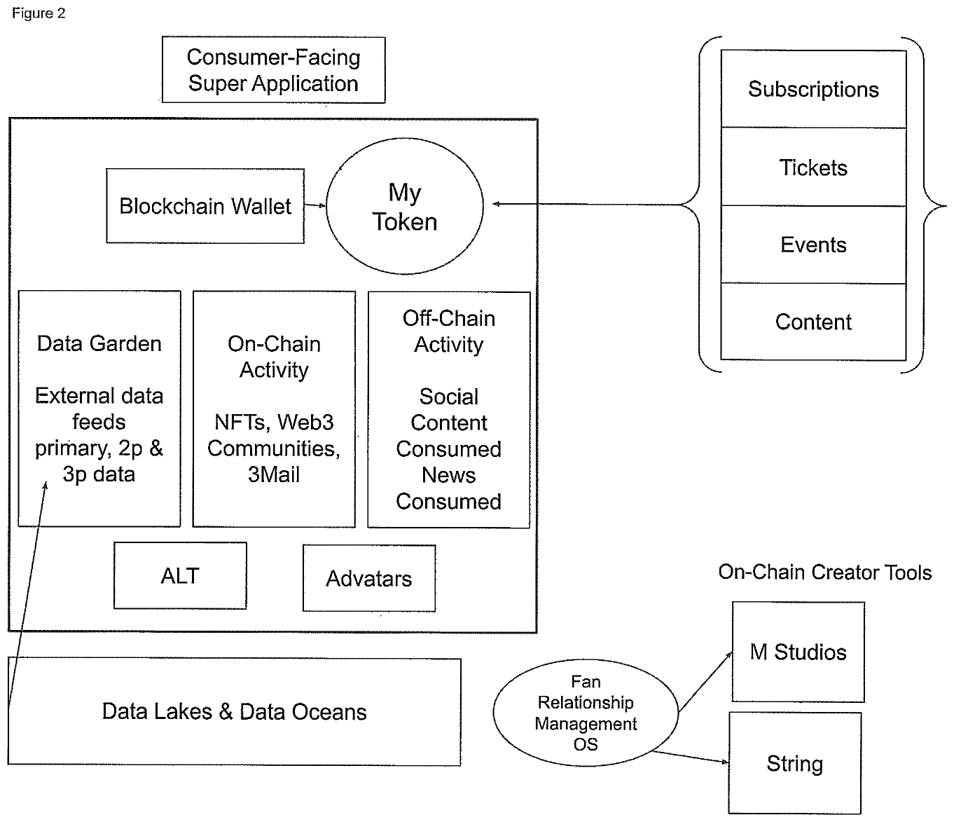

FIG. 2 shows a Web3 Marketing Tool that contains a Fan Relationship Management OS, Consumer Identity and On-Chain Creator Tools. The Consumer Identity comprises a Blockchain Wallet, Data Garden, ALT, Advatars and Fan Relationship Management OS. This system works with Subscriptions, Content, Tickets and Events. The On-Chain Creator Tools include String and M.Studios.

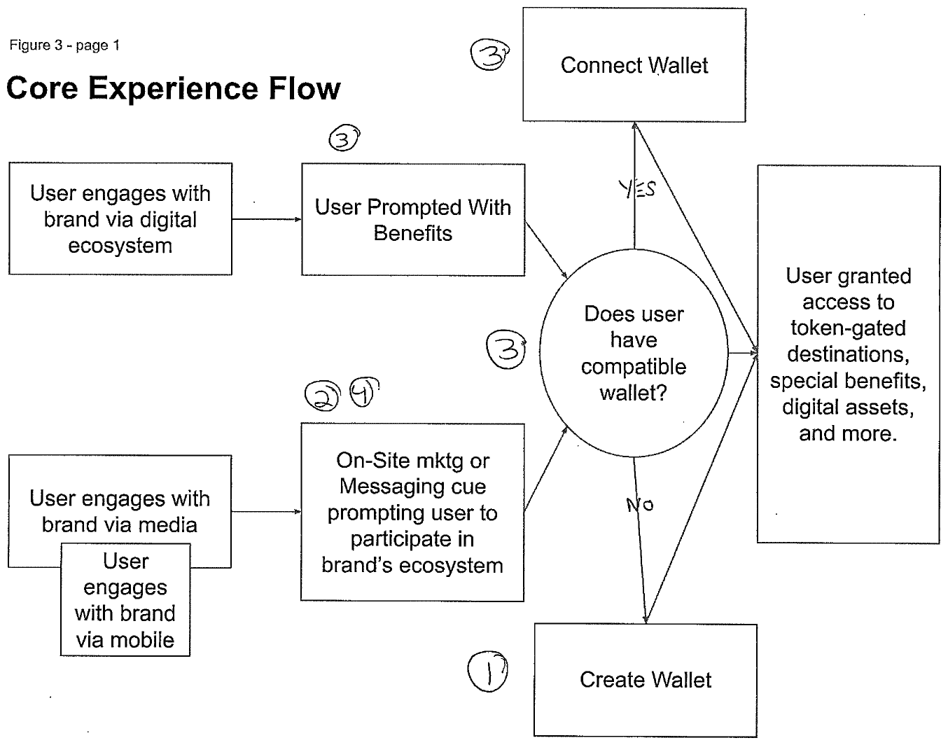

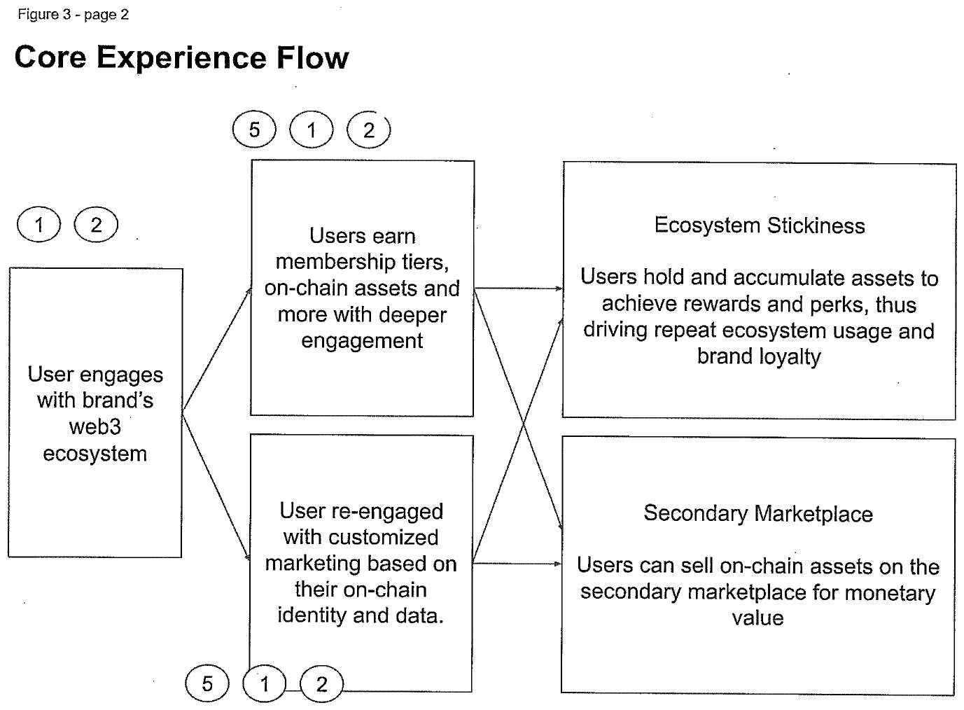

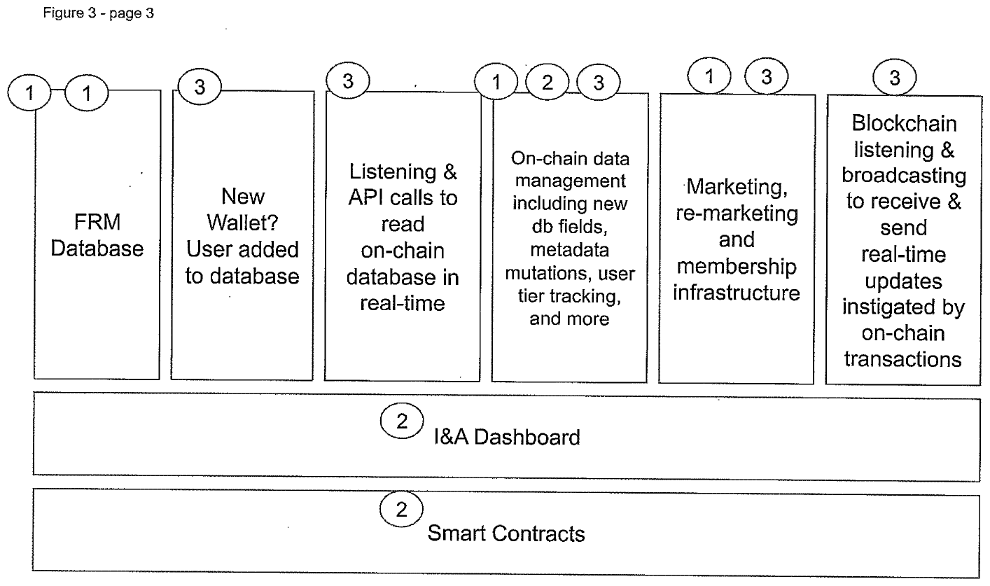

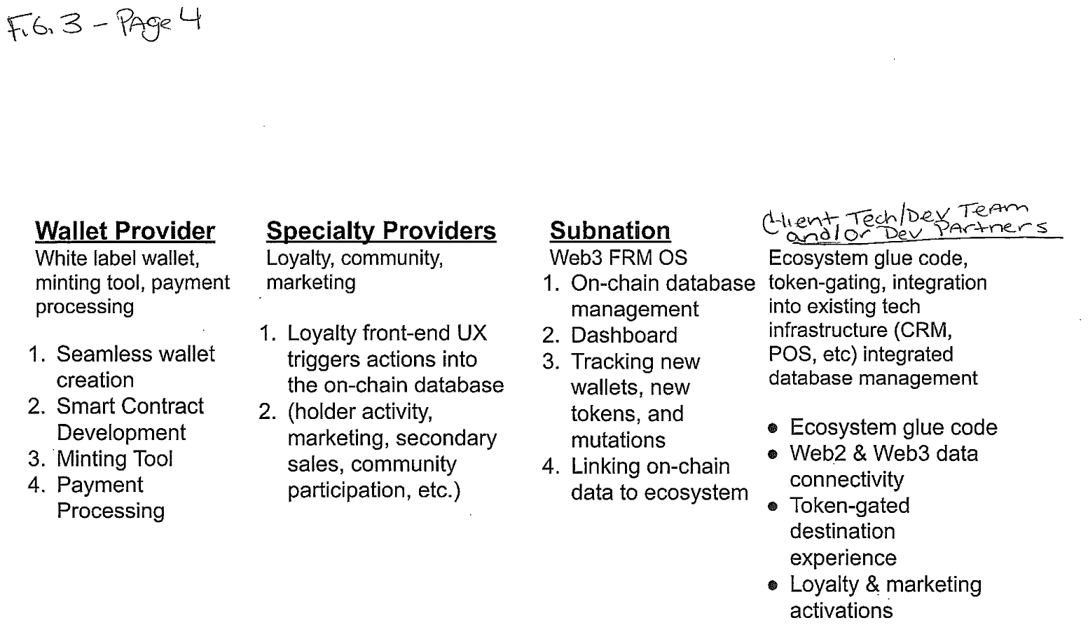

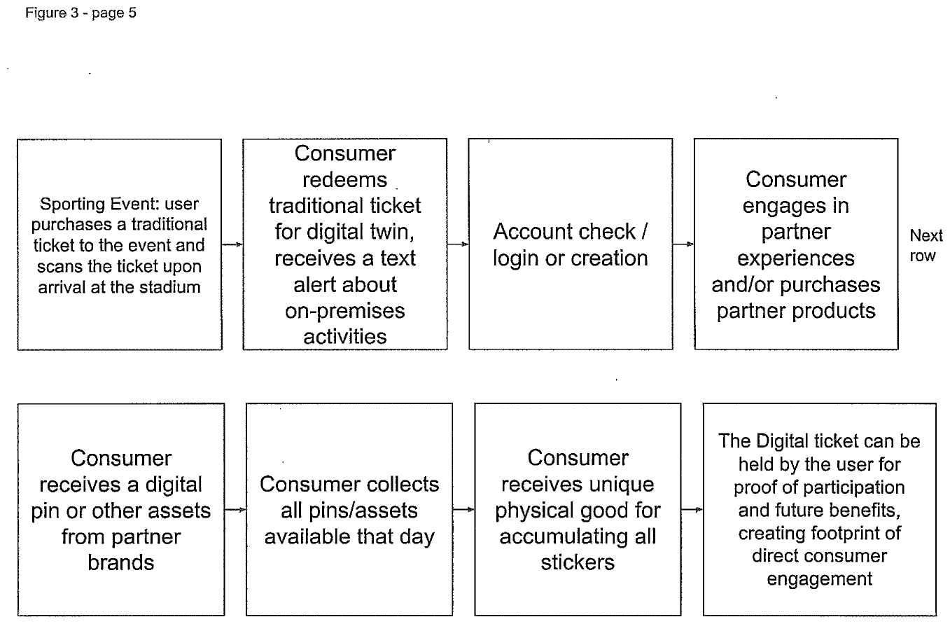

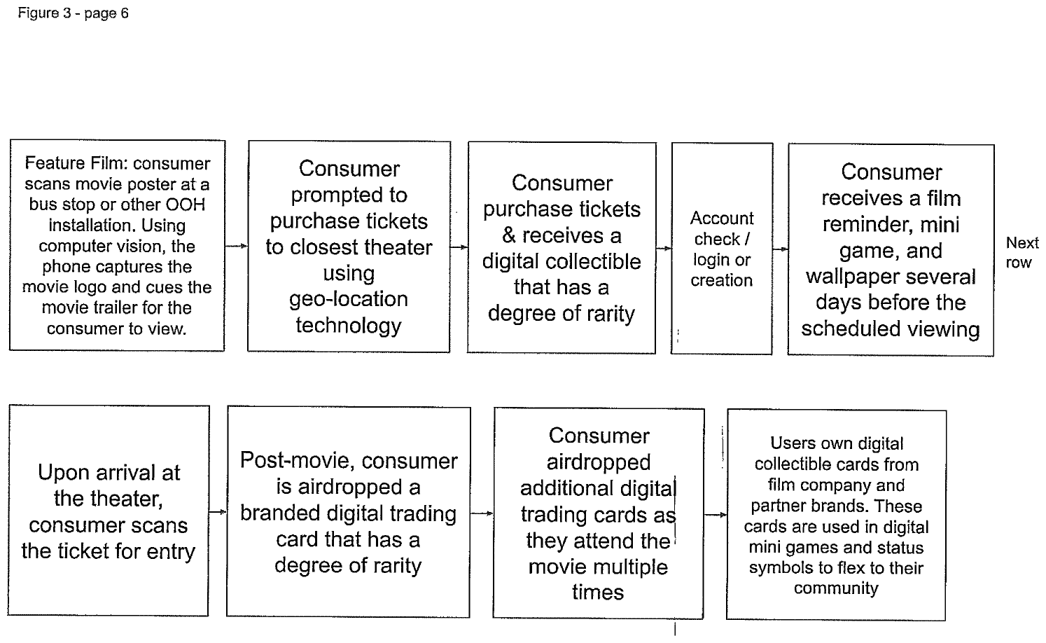

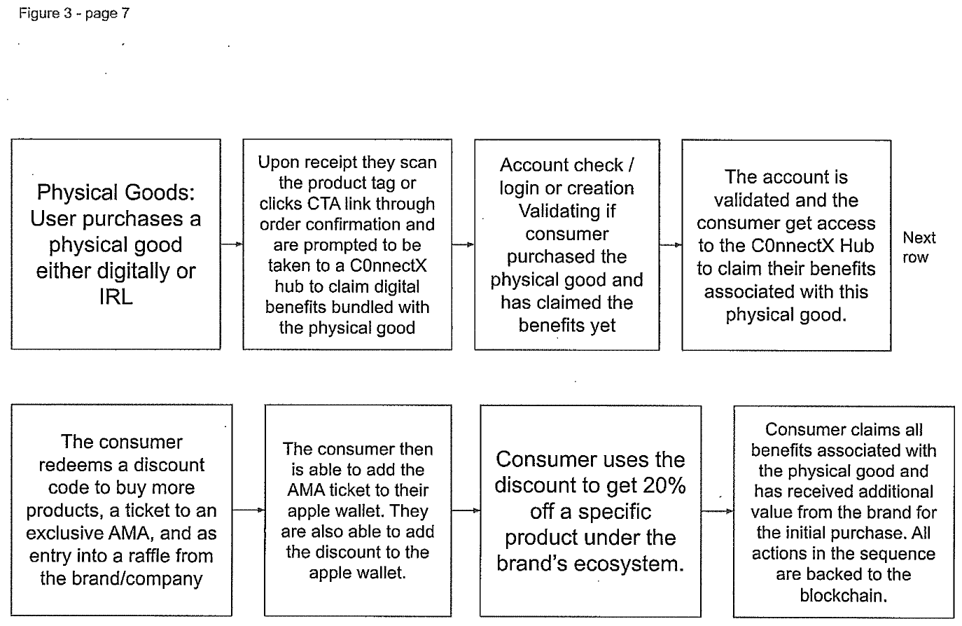

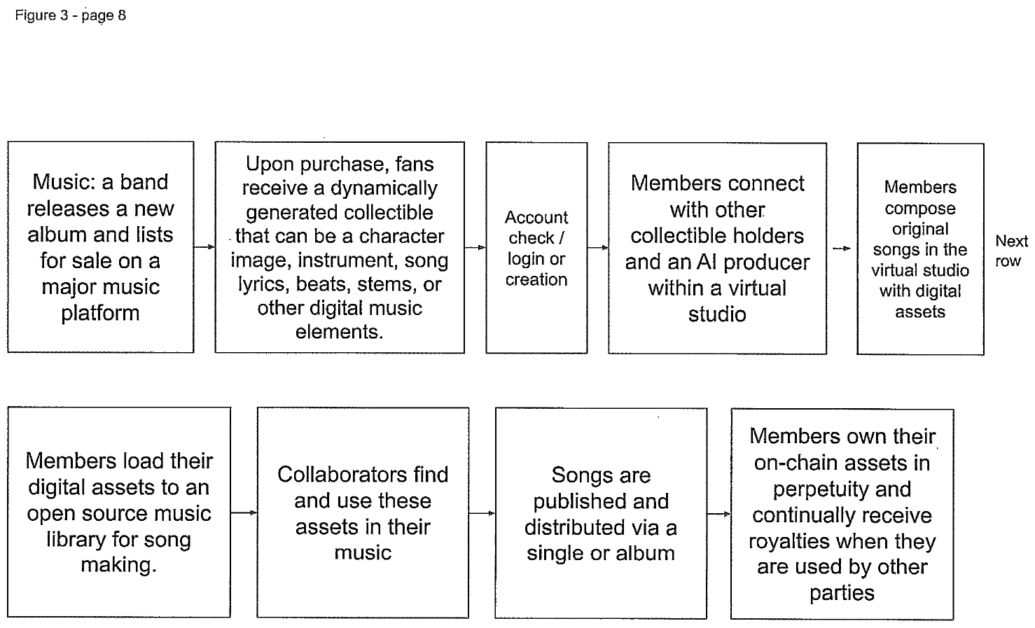

FIG. 3 provides a flow chart relating to Core Flow Experience, Web3 Tools and Use Cases. The Flow chart shows I&A Dashboard and Smart Contracts.

The System includes Wallet Providers, Specialty Providers, Web3 FRM OS and Client Tech/Dev Team and or Dev Partners. The Wallet Provider includes White Label Wallet, minting tool and payment processing. The Specialty Providers includes Loyalty, Community and Marketing. The Web3 FRM OS includes: On-Chain database management, Dashboard, Tracking of new wallets, new tokens and linking on-chain data to eco-system. The Client Tech/Dev Team and/or Dev Partners includes: Ecosystem Glue code, token-gating, integration into existing tech infrastructure and integrated database management.

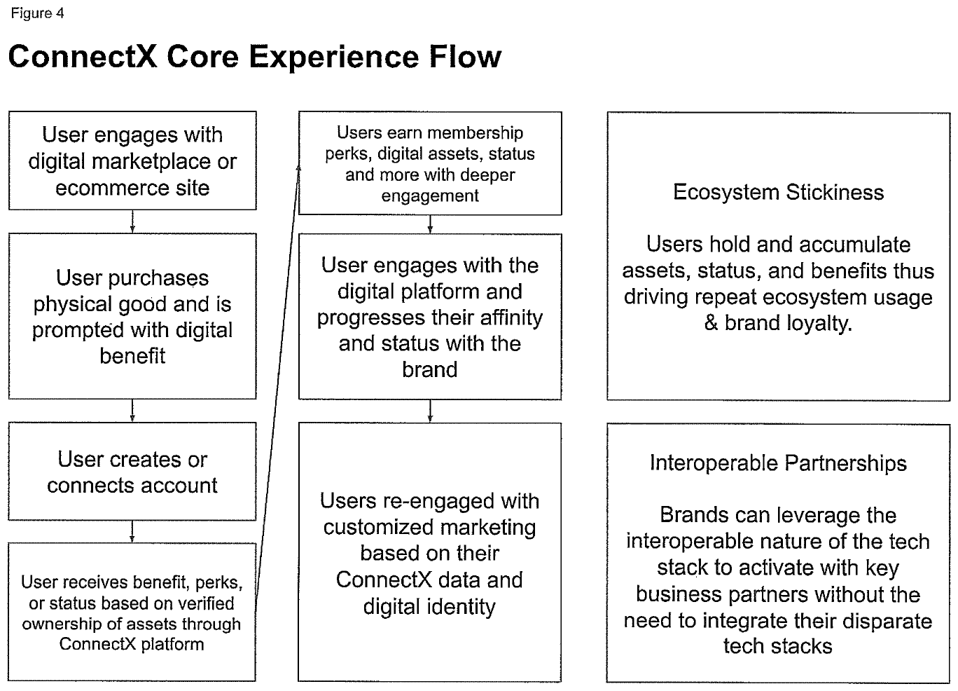

FIG. 4 is a flow chart showing that the user engages with the digital marketplace or e-commerce platform. The user purchases a physical good and is prompted with a digital benefit. The system then determines whether the user has a compatible account. If the account is compatible the user is connected to the system. If the user does not have a compatible account an account is created for them. The next step is the user receives benefits, perks or status based on verified ownership of the assets through the system platform. The user continues to engage with the digital platform and progresses their affinity and status with the brand. The user then earns membership tiers, digital assets, status and more deeper engagement or the user is re-engaged with customized marketing based on their data and digital identity. The system creates ecosystem stickiness by the user accumulating assets, status and benefits, thus driving repeat ecosystem usage and brand loyalty. The system platform provides interoperable partnerships. Brands can leverage the interoperable nature of the tech stack to activate with key business partnerships without the need to integrate their disparate tech stacks.

FIG. 5 illustrates the systems core database. The system creates accounts and adds them to the database. The system listens and API calls to read and update the database in real time. Data management includes new db fields, user tier tracking and more. The system provides re-marketing and membership infrastructure. The system has active db integrations with the system and digital platform brands to receive and send real-time updates instigated by member activity.

The platform has databse management; I and A dashboard for digital platform brands; tracking new accounts, member activity and brand activations; and linking of the system data to partner brand data systems.

The digital platform provides an ecosystem glue code, integration into existing tech infrastructure (CRM, POS), integrated database management. This provides specific consumer benefits and bundles; partner marketing activations and loyalty and marketing activations.

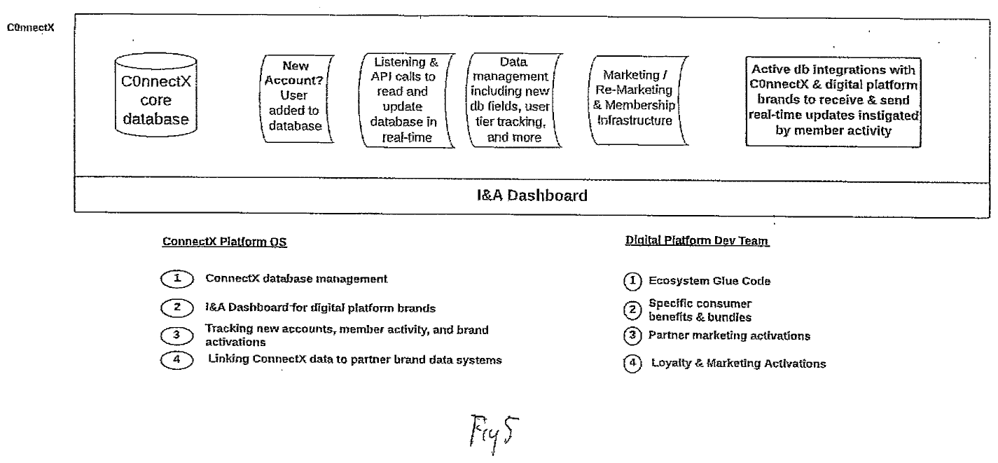

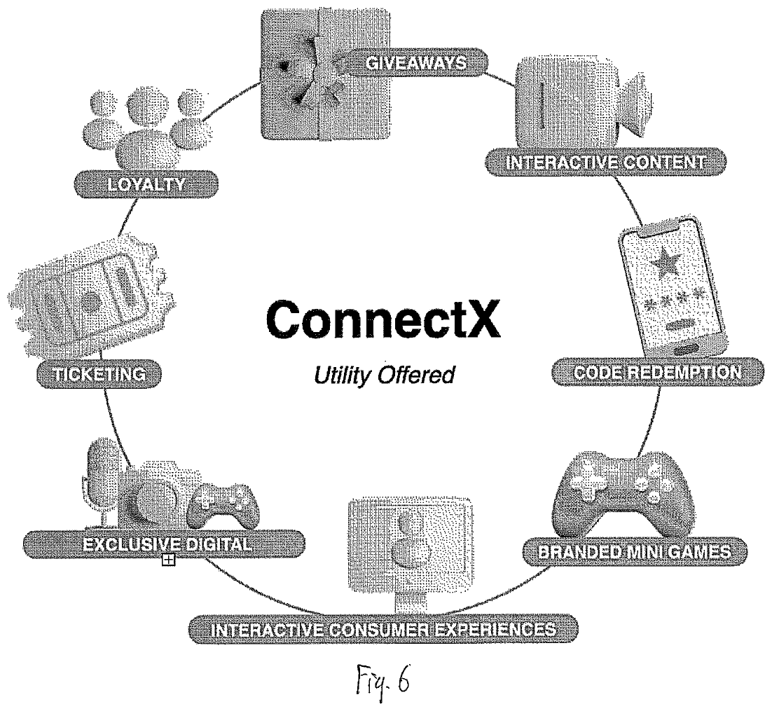

FIG. 6 shows the utility offered by the system of the present invention. The utilities include: loyalty; giveaways; interactive content; code redemption; branded mini-games; interactive consumer experiences; exclusive digital content and/or ticketing.

The Use cases include Sporting Event, Feature Film, Fashion and other physical goods, and Music and band releases.

### Example Use Case for an E-Commerce Platform

A consumer visits an e-commerce platform and sees a physical product, such as a cosmetic item or other CPG brand, for sale with bundled digital utilities attached. These utilities include entry into a giveaway, a ticket to an AMA with a famous influencer, and a 30% store-wide discount as examples. The benefits are detailed either in the product description, attached photos, or through an indication of a QR code or scannable ID associated with the product.

The consumer purchases the product with the bundled digital utilities. Upon either receipt of the good or verification of purchase, an email or claim instructions are sent to the customer, directing them to scan the QR code or click a link provided in the outreach method. Once the user clicks the link, they are brought to a system hub, an extension of the product offer.

At the system hub, the user is prompted to log in with the e-commerce provider from which they originally purchased the item. When the user logs in, it can create a blockchain wallet or just a basic web2 account, depending on the platform's needs. Once the user logs in and their information is verified through the e-commerce provider's platform APIs or system custom APIs, system validates the purchase of the product and ensures the benefits have not yet been claimed by checking the purchase history through the e-commerce platform's internal records tied to the store information from the purchase.

The system imprints sales data onto its blockchain-powered database, ensuring swift and secure data validation with initial provenance. This database structure validates ownership of the original product and then executes the utility mechanisms based on the selected options via the user interface. In this case, the user has proven they own the product and have yet to claim the three digital benefits associated with the item.

With access to the system hub, the consumer can now claim the three benefits. For the discount code, when the user presses the claim button on the system hub platform, the backend system validates that the codes are unused and registered to the originating brand, securely processing and delivering the code to the user. The user can copy the code or press a button that copies it to their clipboard.

For the AMA ticket, the delivery function works similarly but delivers a file that can be added to the user's Apple Wallet following Apple's standard progression. All codes are saved to the consumer's account on the system.

The giveaway entry functions similarly to the previous benefits but includes an additional step where the user enters and submits additional information. The backend system then validates this information from internal records and processes it if correct.

This system use case will work with any offer product, promotion, or reward beyond the examples provided.

### Example Use Case for a Residential Tenant in a Mixed-Use Building

A new tenant signs a lease for an apartment in a mixed-use building, which includes commercial retail space on the ground floor and residential apartments on the upper floors. The lease terms detail the amenities available within the building. On the ground floor, there is a specialized kiosk, OOH screen, or hardware unit that serves as the system hub for the building's residential tenants. These specialized kiosks, OOH screens, or hardware solutions can be used on any floor, indoor or outdoor, and will be used as physical entry points into system's digital ecosystem.

Once the lease is signed, the building management instructs the tenant to create a system account using their email or by signing in with a social platform like Google or Facebook. This login will be used for the system, as well as for paying bills, rent, and collecting “amenity passes” as per their lease terms. Once the tenant creates an account, they gain access to the digital touchpoints of the system hub, which they can access on their devices or interact with directly at the kiosk.

The tenant, as part of their lease, receives several amenities, including monthly benefits for streaming video services on subscriptions, gift cards, and the ability to choose a unique partner benefit each month depending on their lease payment status (early or late). The process for claiming benefits is as follows:
Streaming Video Service Rebates: The tenant logs into the system hub and selects the streaming video service rebate option. The system validates the tenant's lease status and payment history, ensuring the benefit rebate is due. Once validated, the rebate is processed, and the tenant receives a credit or reimbursement for their streaming video service subscription.
Partner Gift Card: To claim the gift card, the tenant selects the gift card benefit option in the system hub. The backend system verifies the tenant's eligibility, checks the availability of the gift cards, and securely delivers the digital gift card to the tenant's account. The tenant can then redeem the gift card directly from their device.
Unique Monthly Benefit: Depending on their lease payment status, tenants can choose a unique monthly benefit. They select the desired benefit from a list of options in the system hub. The system verifies the tenant's eligibility and processes the chosen benefit, whether it be a discount at a local retailer, an additional amenity pass, or another special offer. The benefit is then securely delivered to the tenant's system account.

This system use case will work with any offer product, promotion, or reward beyond the examples provided.

### Example Use Case for a Commercial Retail Tenant in a Mixed-Use Building

A commercial retail tenant signs a lease for a retail space on the ground floor of a mixed-use building. The lease includes various benefits and utilities to enhance their business operations and customer engagement.

Upon signing the lease, the retail tenant is instructed to create a system account using their business email or by signing in with a business-related platform. This account will be used for managing lease payments, accessing utilities, and claiming business-related benefits.

The commercial retail tenant receives several utilities and benefits as part of their lease agreement. These might include promotional support, digital marketing credits, and customer engagement tools. The process for claiming benefits is as follows:
Promotional Support: The retail tenant logs into the system hub and selects the promotional support option. The system verifies the lease status and ensures the tenant is eligible for promotional support. Once validated, the promotional materials or credits are processed and delivered to the tenant's account, ready to be used for marketing campaigns.
Digital Marketing Credits: To claim digital marketing credits, the tenant selects this option in the system hub. The backend system verifies the eligibility and availability of the credits. Once verified, the credits are securely delivered to the tenant's system account, where they can be applied to various digital marketing platforms.
Customer Engagement Tools: The retail tenant can choose from a suite of customer engagement tools offered through the system hub. These tools might include loyalty programs, interactive content, or special event access. The tenant selects the desired tools, and the system verifies their eligibility. Once approved, the tools are activated and integrated into the tenant's operations, enhancing customer engagement and satisfaction.
   This system use case will work with any offer product, promotion, or reward beyond the examples provided.

### Example Use Case for an In-Store Retail Experience

A consumer walks into a retail location and purchases a T-shirt. Upon making the purchase, the user scans the code associated with the tag on the T-shirt, which directs them to a system hub. This hub presents the user with access to specific benefits, such as entry into sweepstakes and access to a fantasy sports competition. The process for claiming these benefits is as follows:
Account Creation or Login: The user creates a system account or logs into an existing account. This account will be used to manage their benefits and interact with the system platform.
Tag Validation: The system validates the tag associated with the T-shirt by checking its status to ensure it is active and valid. This verification ensures that the benefits can be claimed by the rightful purchaser of the product.
Accessing Benefits: Once the tag is validated, the user gains access to the system hub, where they can claim their benefits. The process for each benefit follows the standard system redemption procedures:
   Sweepstakes Entry: The user selects the sweepstakes entry option in the system hub. The backend system verifies the user's eligibility, processes the entry, and confirms participation in the sweepstakes.
   Fantasy Sports Competition: The user selects the fantasy sports competition option. The backend system verifies eligibility and provides access to the competition. The user receives the necessary information and resources to participate, all managed through the system hub.
      This use case will work with any offer product, promotion, or reward beyond the examples provided.
      All benefits are securely processed and delivered through the system hub, ensuring a seamless and personalized experience for the consumer.

### Example Use Case for a Sporting, Music, or Live Event

A consumer purchases a ticket to an event, which includes bundled digital utilities with inherent benefits. As the user approaches the venue, a geofence alert activates, notifying the ticket holder of the benefits associated with their ticket. These benefits might include a discount on merchandise in the stadium, a free concession item or drink from a partner sponsor, or access to an exclusive event within the venue. To claim these benefits, the user clicks the link in the notification and is directed to a system hub. Here, the user logs in with their information from the ticketing provider or the event. If the user does not already have an account, one is created for them on the system, tied to their account from either the event or the ticket provider.

### Example Use Case for Exclusive Event Access

A consumer receives exclusive event access as a benefit for purchasing a product or service. The process for claiming this benefit is as follows:
Claiming the Benefit: The user receives an invitation or notification about the exclusive event access and is directed to claim the benefit through the system hub. This could be through a link provided in an email, SMS, or through the system platform.
Account Creation or Login: The user logs into their existing system account or creates a new one if they do not already have an account. This account will be used to manage their benefits and interact with the system platform.
Verification and Validation: The system's backend system verifies the user's eligibility for the exclusive event access. This may involve checking purchase history, event invitations, or other criteria to ensure the user qualifies for the benefit.
Delivery of Digital Ticket: Once the user's eligibility is confirmed, the backend system delivers an entry pass or digital ticket to the user. This ticket is designed to be easily added to the user's digital wallet (e.g., Apple Wallet or Google Wallet) for convenient access during the event.
Accessing the Event: The user can now use their digital ticket to gain entry to the exclusive event. The digital ticket includes all necessary information and barcodes/QR codes for seamless entry.

### Benefits and Features

Personalized Experience: All benefits are saved to the user's account on the system, ensuring a seamless and personalized experience.
Secure Validation and Delivery: This structured approach guarantees that the benefits are securely validated and delivered efficiently, enhancing the overall experience for the consumer attending the event.
Specialized Kiosks and OOH Screens: The system will also use specialized kiosks, OOH screens, or hardware units that serve as the system hub for the building's tenants. These specialized kiosks and screens can be used on any floor, indoor or outdoor, as physical entry points into the system's digital ecosystem.
   The system use case will work with any offer product, promotion, or reward beyond the examples provided.

1. A method of integrating partner infrastructures comprising:
internal system APIs and blockchain technology that authenticate user identity;
ensuring individuals are who they claim to be and possess requisite rights to access and process information on said system;
validating ownership or participation of a user by a system that ensures user data is accurately and securely transmitted;
securely distributing benefits to said user;
interfacing with a provider's internal infrastructure;
enhancing user experiences with seamless interactions.

2. The method of claim 1 wherein URI mapping is incorporated as a supplementary validation method to enhance verification process.

3. The method of claim 1 wherein once validation is complete, said system sequences distribution of benefits associated with initial touchpoint.

4. The method of claim 1 wherein said system provides loyalty programs that encourage repeat engagements through reward systems.

5. The method of claim 1 wherein said system provides integrated ticketing solutions that facilitate seamless event access and participation.

6. The method of claim 1 further comprising, offering code redemption, promotional codes and discounts to enhance value of interactions.

7. The method of claim 1 further comprising offering interactive fan experiences, engaging consumers with interactive content and experience.

8. The method of claim 1 further comprising providing giveaways and exclusive digital content.

9. The method of claim 1 further comprising, branded mini-games and interactive content to keep consumers engaged and connected with a brand.

10. The method of claim 1 further comprising, providing data monetization enabling an end user to harness and monetize their own data, turning insights from engagements into actionable improvements.

11. The method of claim 1 wherein said system provides bundling of branded digital products and experiences with an initial point of sale, enhancing consumer engagement and perceived value.

12. The method of claim 1 wherein said system creates increased brand loyalty, by offering bundled benefits which continuously reward consumers for their purchases.

13. The method of claim 1 wherein said system creates higher margins and average order value.

14. A system for providing a consumer with bundled digital utilities upon purchase of a product comprising:
said system an email or instructions sent to said consumer upon receipt of a good or verification of purchase;
said email directing said consumer to scan a QR code or click a link provided;
once said user clicks said link, said consumer is are brought in said system to an extension of a product offer.

15. The system of claim 14 wherein said system creates a block chain wallet or basic Web II account depending on said platform.

16. The system of claim 14 wherein once said consumer logs in and their information is verified through e-commerce providers platform APIs or customer APIs, said system validates said consumer of the product and ensures benefits have not yet been claimed by checking purchase history through said e-commerce platforms internal records tied through records.

17. The system of claim 14 wherein said system imprints sales data onto its block chain-database ensuring swift and secure data validation with an initial provenance;
database of said system validates ownership of original product and executes a utility mechanism based on selected options via user interface;
once system determines consumer has proven they own said product and have yet to claim digital benefits associated with said product.

18. The system of claim 14 comprising a discount code, wherein when said consumer presses a claim button in said system, back end system validates codes are unused and registered to originating brand, securely processing and delivering said code to said user.

19. System for bundling utilities for use with a residential tenant in a mixed use building comprising:
system allows a tenant to sign a lease for an apartment in said mix use building;
said mix use building having commercial retail space on ground floor and residential apartments on upper floors;
lease terms detail amenities available within said building,
said ground floor including a specialized kiosk, OOH screen or a hardware unit that serves as system hub for buildings residential tenants;
said specialized kiosks, OOH screens or hardware solutions used on any floor, indoor or outdoor and used as physical entry points into systems digital eco system;
once said lease is signed, building management instructs said tenant to make account of said system using their email or by signing in with a social platform;
said login used for both said system, as well as paying bills, rent, and collecting amenity passes as per their lease terms;
once said the tenant creates an account, said tenant gains access to digital touch point of said system, to access on their devices or interact directly at said kiosk.

20. The system of claim 19 wherein said tenant, as part of their lease, receives monthly benefits for streaming video services on subscriptions, gift cards, and ability to charge a unique partner benefit each month depending on lease payment status, early or late.

21. The system of claim 19 wherein said system provides streaming video service rebates;
said tenant logins to said system and selects said streaming video service rebate option;
said system validates said tenants lease status and payment history, ensuring said benefit rebate is due;
once validated said rebate is processed and said tenant receives a credit or reimbursement for said streaming video service.

22. The system of claim 19 wherein said system provides a partner gift card;
to claim said gift card, said tenant selects gift card benefit option in said system;
back end system verifies said tenants eligibility, checks availability of said gift cards and securely delivers said gift card to said tenant's account;
said tenant can then redeem said gift card to their device.

23. The system of claim 19 wherein said system is used for a commercial retail tenant in a mixed use building.

24. The system of claim 23 wherein said commercial retail tenant receives several utilities and benefits as part of their lease agreement, promotional support, digital marketing credits and customer engaging tools.

25. System for bundling utilities for in-store retail experience comprising:
a consumer arrives to a retail location and purchases an item;
upon making purchase, said consumer scans a code associated with a tag on said item, which directs said consumer to said system which presents said consumer with access to specific benefits;
said system having an account creation or login;
said account used to manage consumer benefits and interact with system platform;
said system having a tag validation that validates said tag associated with said item by checking its status in said system to ensure it is active and valid, verification ensures benefits can be claimed by rightful consumer purchaser said item;
once tag is validated, said consumer gains access to said system where said consumer can claim their benefits.

26. System for bundling utilities for use with a sporting, music or live event comprising:
consumer purchases a ticket to an event, which includes bundled digital utilities with inherent benefits;
as said consumer user approaches a venue, a geofence alert activates, notifying said consumer of said benefits associated with their ticket;
said consumer claims these benefits by clicking a link in the notification directed to said system;
said consumer logs in with information from said ticketing provider or said event,
said system provides uses for exclusive event access;
said consumer receives exclusive event access as a benefit for purchasing a product or services;
said system provides to consumer an invitation or notification about said exclusive event access and is directed to claim benefit through said system.

27. The method of claim 26 wherein said system provides delivery of a digital ticket;
once said consumer's eligibility confirmed, backend system of said system delivers an entry pass or digital ticket to said consumer.

28. The method of claim 27 wherein said digital ticket gains entry to said exclusive event;
said digital ticket includes barcodes/QR codes for seamless entry.
